(19) United States
(12) Patent Application Publication
(10) Pub. No.: US 2021/0010323 A1
(43) Pub. Date: Jan. 14, 2021

(54) INSULATED DOOR

(71) Applicant: Findoor Industrial Inc., Okotoks (CA)

(72) Inventors: Tauno JAARA, Li (FI); Seppo JAARA, Jakkukylä (FI)

(21) Appl. No.: 16/550,885

(22) Filed: Aug. 26, 2019

(30) Foreign Application Priority Data
Jul. 12, 2019 (CA) 3049323

(51) Int. Cl. E06B 5/16; E06B 3/48; E06B 3/70

(52) U.S. Cl. CPC E06B 5/164; E05Y 2900/134; E06B 3/7015; E06B 3/485

(57) ABSTRACT

Disclosed herein is an insulated door which is thermally insulating, low maintenance and easy to operate, even where the door is large and/or constitutes multiple panels. The insulated door is surrounded by a door frame. The door may comprise one or more insulated panels, where each of the panels has four edges, and at least one edge is insulated with a thermal seal. The door has at least one lower lifting hinge and at least one upper sliding hinge connecting the door to the door frame. An exterior mounted first latch may be included for maintaining the insulated door in a closed position.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which is/are hereby incorporated by reference: Canadian App. No. 3,049,323 filed Jul. 12, 2019

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

This invention relates to an insulated door, more particularly to an insulated exterior building door.

Industrial buildings such as barns, fire stations, airports, car dealerships, fabrication plants, distribution centers, power stations and car washes often have large doorways, to allow for large vehicles or machinery to enter and leave the buildings. Doors for such doorways are often one-piece garage doors which may be drafty, thermally inefficient, heavy, unwieldy and/or may require frequent maintenance.

It may be desirable for building doors, particularly exterior building doors, to be thermally insulating, in order to minimize the extent to which heat may pass through the door.

It may be desirable for building doors to be easy to operate, particularly when the doors are large and/or comprise multiple panels.

It may be desirable for building doors to require little maintenance.

### BRIEF SUMMARY OF THE INVENTION

In one embodiment, an insulated door is provided. The insulated door is surrounded by a door frame. The door may comprise one or more insulated panels, where each of the panels has four edges, and at least one edge is insulated with a thermal seal. The door has at least one lower lifting hinge and at least one upper sliding hinge connecting the door to the door frame. An exterior mounted first latch for maintaining the insulated door in a closed position is also present.

In some embodiments, the thermal seals may be secured to all four sides of each panel, and optionally may have complementary shapes to ensure a tight fit at abutting edges.

In some embodiments, the insulated door may include a guide pin attached to a top edge of at least panel. A guide rail is mounted above the door and configured to slidably engage with the guide pin, whereby the insulated door easily slides open and shut as the guide pin slides along the guide rail.

In an embodiment, the insulated door has at least one lower lifting hinge. The lower lifting hinge comprises a first plate comprising a first cylindrical housing and mounted to the door and a second plate comprising a second cylindrical housing and mounted to the door frame. A ramp is secured to the second plate. A rotating member is secured to the first plate. A pin is sized to fit within the first and second cylindrical housings. When the door is opened, the rotating member travels up the ramp while the first plate rotates about the pin, thus raising the door relative to the door frame.

In an embodiment, the insulated door has at least one upper sliding hinge. The upper sliding hinge comprises: a first plate comprising a first cylindrical housing and mounted to the door and a second plate comprising a second cylindrical housing and mounted to the door frame. A pin is sized to fit within the first and second cylindrical housings. When the door is opened, the first plate rotates about the pin, while the door and first plate rise in relation to the pin, thus accommodating the lifting action generated by the lower lifting hinge.

In an embodiment, the insulated door has an exterior mounted first latch. The first latch comprises a first engaging member attached to the door which engages with a first retaining member attached to the door frame. The first engaging member may be actuated by a first actuating member.

### BRIEF DESCRIPTION OF THE SEVERAL VIEWS OF THE DRAWINGS

FIG. 1A is a front perspective view of the door, according to one embodiment.

FIG. 1B is a rear perspective view of the door, according to one embodiment.

FIG. 2 is a perspective view of a top portion of a folding door according to one embodiment.

FIG. 3 is a perspective view of a bottom portion of the door, according to one embodiment.

FIG. 4 is a perspective view of a folding door according to one embodiment, in an open position.

FIG. 5 is a perspective view of a bottom hinge portion of the door, according to one embodiment, wherein the door is in an open position.

FIG. 6 is a perspective view of a bottom hinge portion of the door, according to one embodiment, wherein the door is in a closed position.

FIG. 7 is a perspective view of a top hinge portion of the door, according to one embodiment, wherein the door is in an open position.

FIG. 8 is a perspective view of a top hinge portion of the door, according to one embodiment, wherein the door is in a closed position.

FIG. 9 is a perspective view of a top portion of the door, according to one embodiment, wherein the door is in a closed position.

FIG. 10 is a perspective view of the door, according to one embodiment, wherein the door is in a closed position.

FIG. 11 is a perspective view of the door, according to one embodiment, wherein the door is in an open position.

FIG. 12A is perspective view of the first plate of the lower lifting hinge, according to one embodiment.

FIG. 12B is a perspective view of the second plate of the upper or lower lifting hinge, according to one embodiment.

FIG. 13 is a side view of the door, according to a one embodiment.

FIG. 14A is a top view of the handle, according to one embodiment.

FIG. 14B is a side view of the handle, according to one embodiment.

FIGS. 15A-F are cross sectional views of portions of the seals, according to one embodiment.

### DETAILED DESCRIPTION OF THE INVENTION

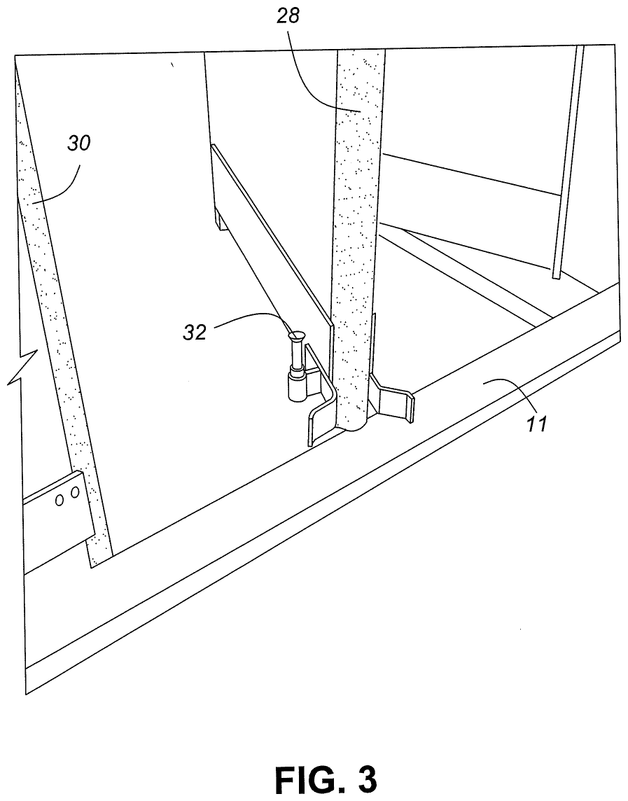

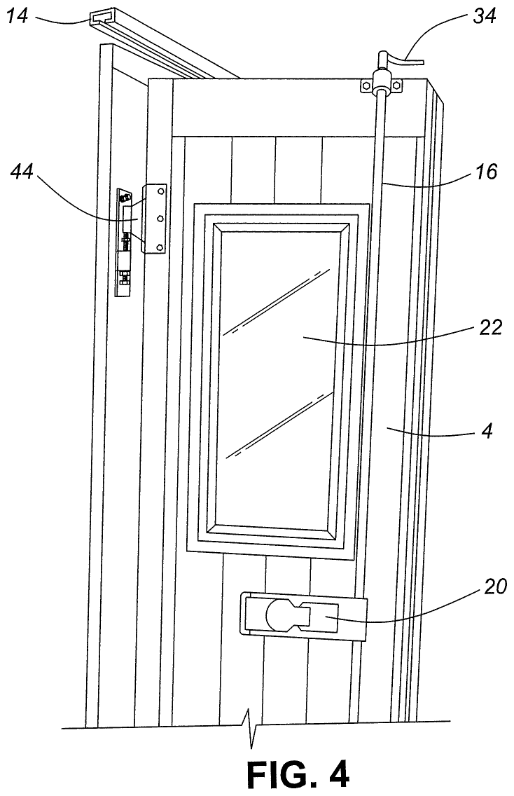

Disclosed herein is an insulated door. The door may include any suitable insulating material known in the art such as, for example, polystyrene, fiberglass, vinyl, or steel. In one embodiment, the insulated door may be clad in sheet steel. In one embodiment, the door may comprise polystyrene. The insulated door may include a seal or gasket on one or more of the bottom edge, the top edge, or the side edges. The seal may extend across at least 50%, at least 60%, at least 70%, at least 80% or at least 90%, or 100% of the width of the door panel edge. The seal (26) may comprise any suitable material, such as tubing, rubber, vinyl, silicone, or other effective air barrier. In one embodiment, the seals are made of rubber. In one embodiment, the hardness of the seals may be measured on the Shore A hardness scale. In one embodiment, the hardness of the seals may be a 65-70 ShoreA. As shown in FIG. 3, for example, the seals may have complementary shapes (28, 30) so as to provide an airtight fit when closed together.

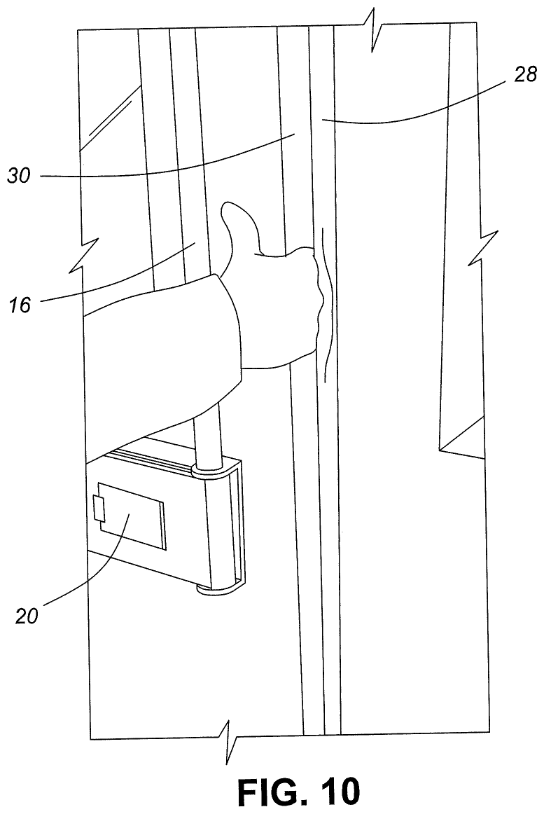

Further, the seals (28, 30) may be deformable to ensure a tight fit. As seen in FIG. 10, for example, a hand may easily be inserted between the seals (28, 30).

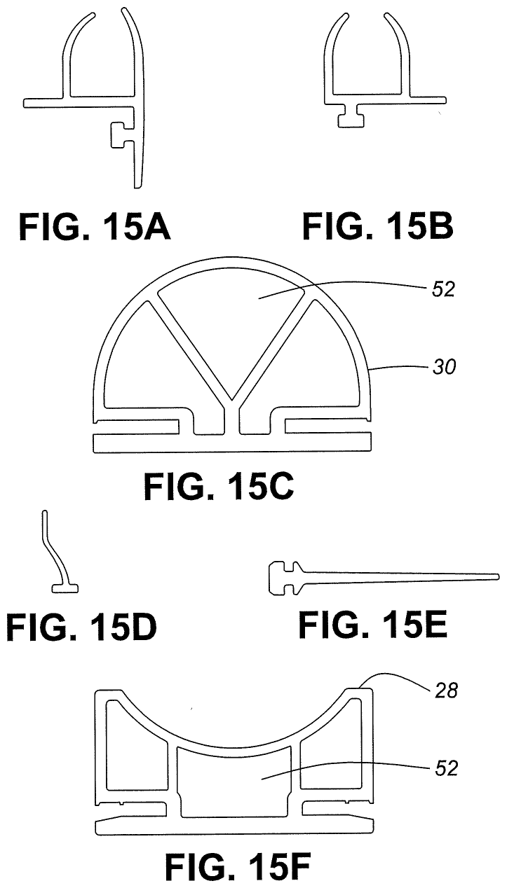

Possible configurations for the seals are shown in FIGS. 15A-F. For example, one seal, as shown in FIG. 15C (30) may have a convex, or male shape, while the complementary seal, as shown in FIG. 15F (28) may have a concave, or female shape. The seals may comprise air pockets (52) which allow the seals to be flexible or deformable in shape (see also FIG. 10). FIGS. 15A, 15B, 15D and 15E illustrate possible shapes for seals located at the top or bottom of the insulated door.

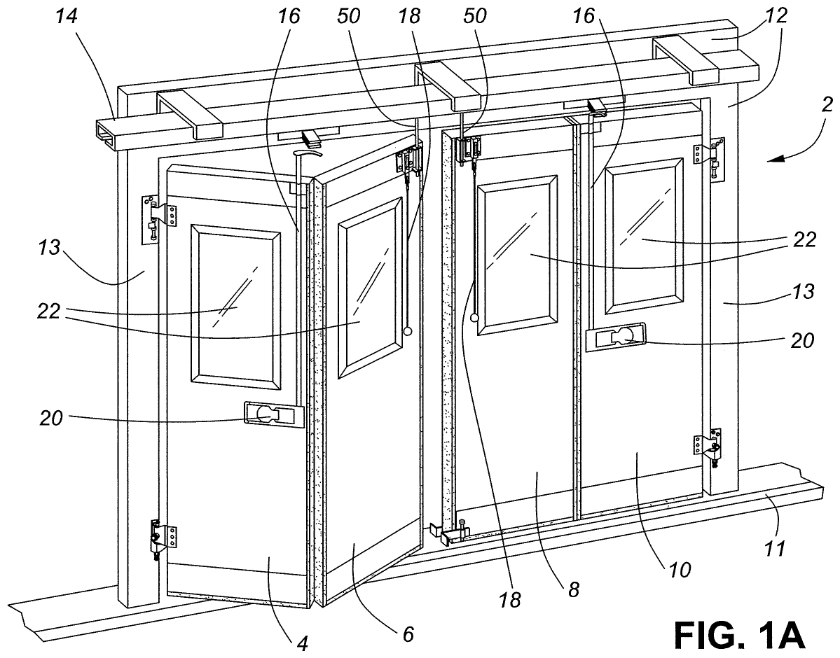

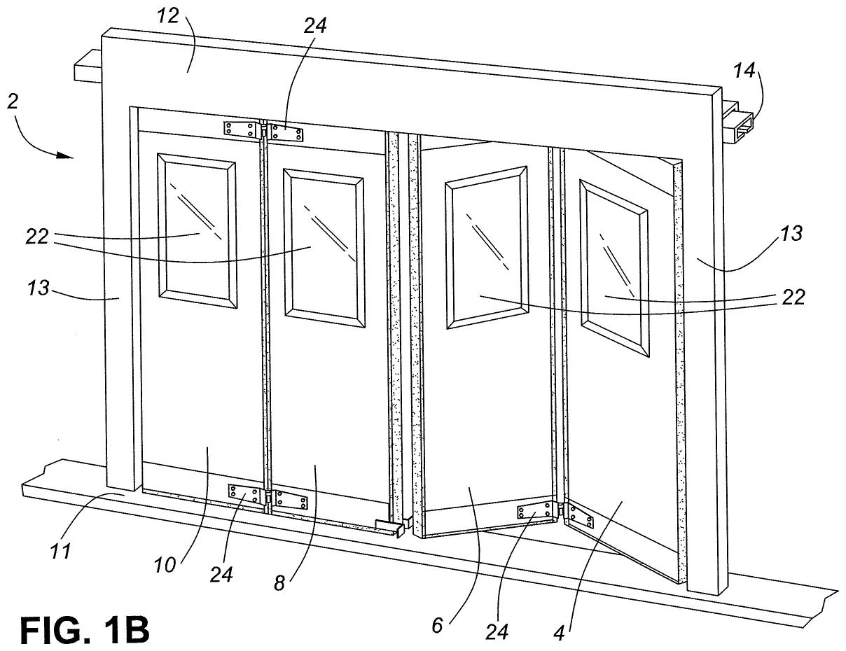

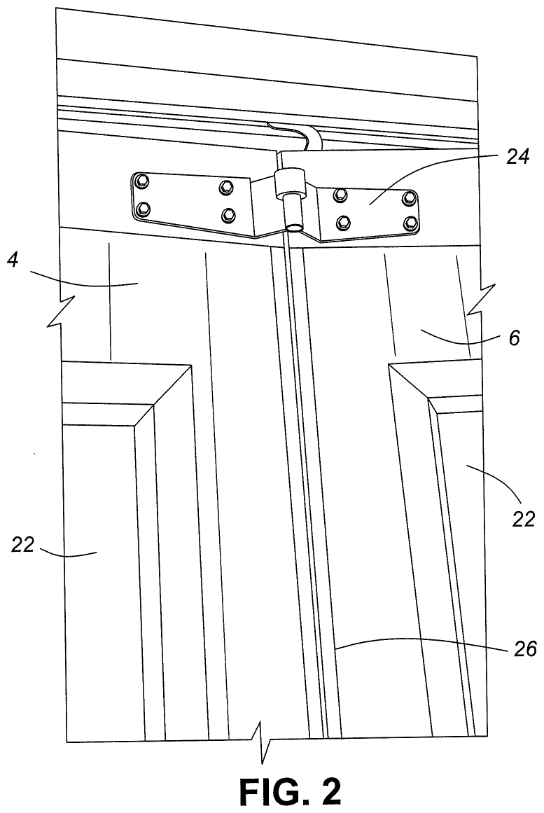

In one embodiment, the insulated door comprises more than one panel. In one or more embodiments, the insulated door may be a folding door with two, three, four or more panels. The insulated door may be a double door, with each side of the double door having one, two or more panels. As shown in FIG. 1A, for example, the insulated door (2) may comprise a double door, each side of the double door comprising two panels (4,6 and 8,10). The two panels may be hinged together by a folding hinge (24)—see FIG. 1B and FIG. 2. If the insulated door is larger than need to admit a person, a person-sized door may be present within the insulated door (not shown).

The insulated door may include windows (22) or may be windowless. If windows are present, they may comprise glass. In some embodiments, the glass may be thermal glass and/or may be double paned.

In preferred embodiments, where the insulated door comprises more than one panel, such as a folding door, the side edges of the mating panels may include complementary seals (28, 30), for example with a male-female configuration, to ensure an airtight fit when the door is closed (see FIG. 3, for example). Optionally, the door may include a bolt (32) which may be used to keep the door in a closed position.

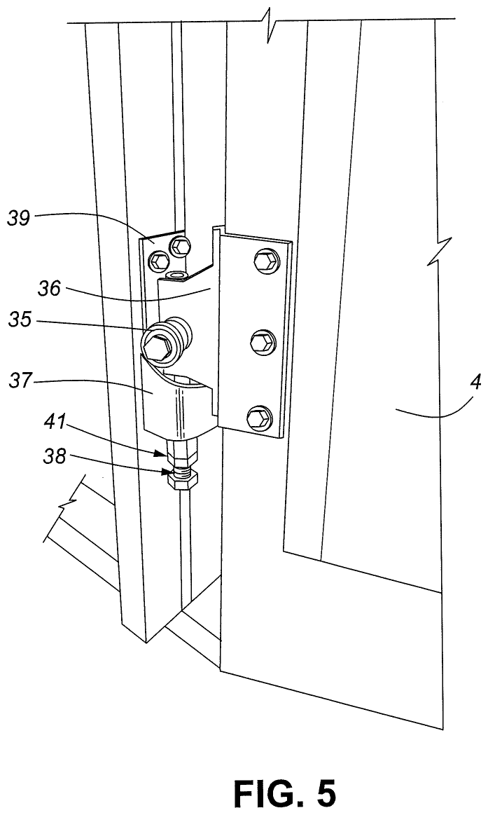

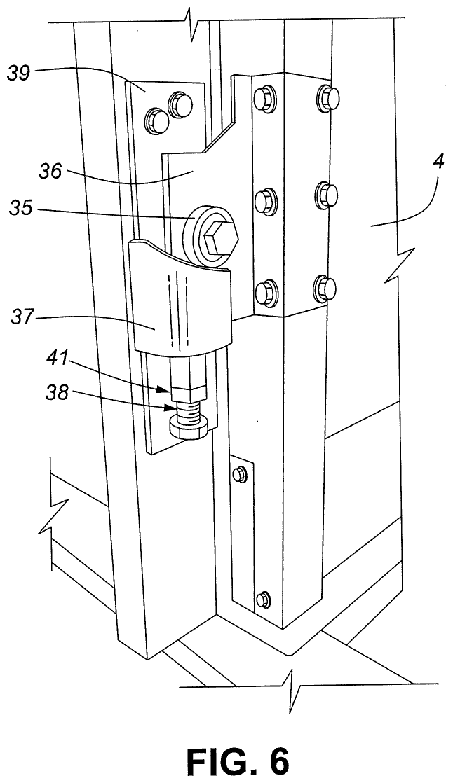

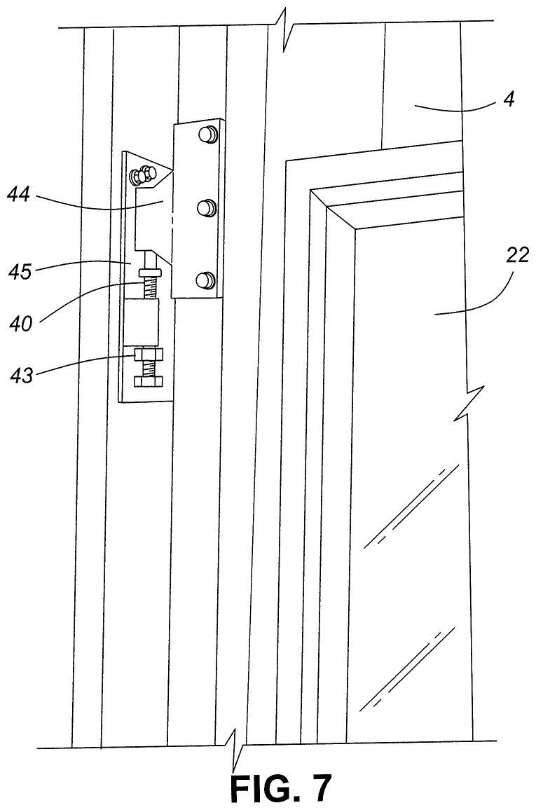

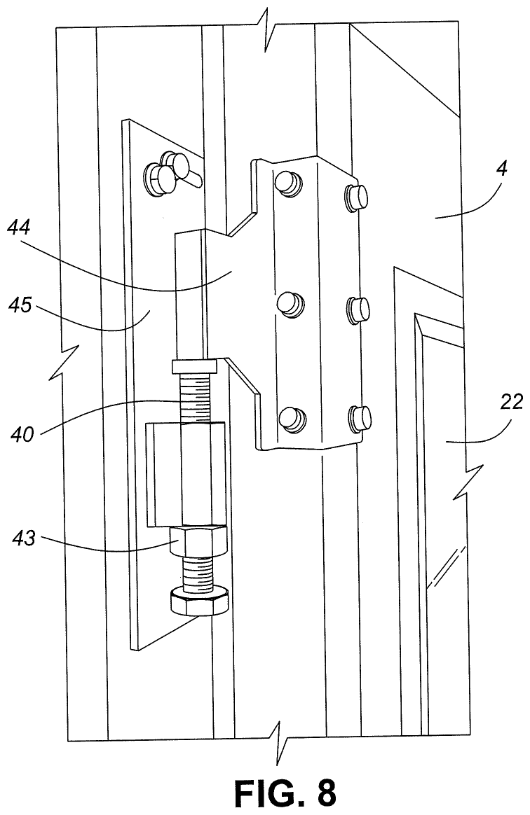

One embodiment disclosed herein comprises a door with lifting hinges, such that when the door is opened, the door rises vertically so as to clear the sill or bottom ledge (11). The lifting hinges may cause the door to be self-closing. In one embodiment, for example as illustrated in FIGS. 5-6, the lifting hinges comprise at least one lower hinge which comprises a cam or ramp (37) to cause vertical movement of the door. In a further embodiment, for example as illustrated in FIGS. 7-8, the lifting hinges comprise at least one upper hinge which comprises a slide post or pin (40) to accommodate vertical movement of the door. Two or more lower lifting hinges and two or more upper sliding hinges may be present depending on the size of the door.

In one embodiment, illustrated in FIGS. 5-6, the lower lifting hinge comprises a first plate (36) mounted to the door and a second plate (39) mounted to the door frame. Both the first and second plates (36, 39) include cylindrical housings to accommodate a pin or bolt (38). Secured to the second plate (39) is a ramp (37) along which rotating member (35) secured to the first plate is adapted to travel. Pin (38) may further include a nut (41). Pin (38) connects the first and second plates (36, 39). As the door opens, rotating member (35) travels up ramp (37), thus lifting the door off the sill while first plate (36) rotates about pin (38). The lower portion of pin (38) may be threaded so as to threadingly engage with the cylindrical housing of second plate (39). Nut (41) may assist in securing this engagement. The upper portion of pin (38) may be smooth so as to facilitate rotation of the cylindrical housing of first plate (36) about the pin (38).

In this embodiment, the upper sliding hinge, as illustrated in FIGS. 7-8, comprises a first plate (44) mounted to the door and a second plate (45) mounted to the door frame. Both the first and second plates (44,45) include cylindrical housings to accommodate a pin or bolt (40). Pin (40) may further include a nut (43). Pin (40) connects the first and second plates (44, 45). The lower portion of pin (40) may be threaded so as to threadingly engage with the cylindrical housing of second plate (45). Nut (43) may assist in securing this engagement. The upper portion of pin (40) may be smooth so as to facilitate rotation of the cylindrical housing of first plate (44) about the pin (40). As the door opens and lifts off the sill, the cylindrical housing of first plate (44) rotates about the pin (40), while the door and cylindrical housing of first plate (44) rise in relation to the pin (40).

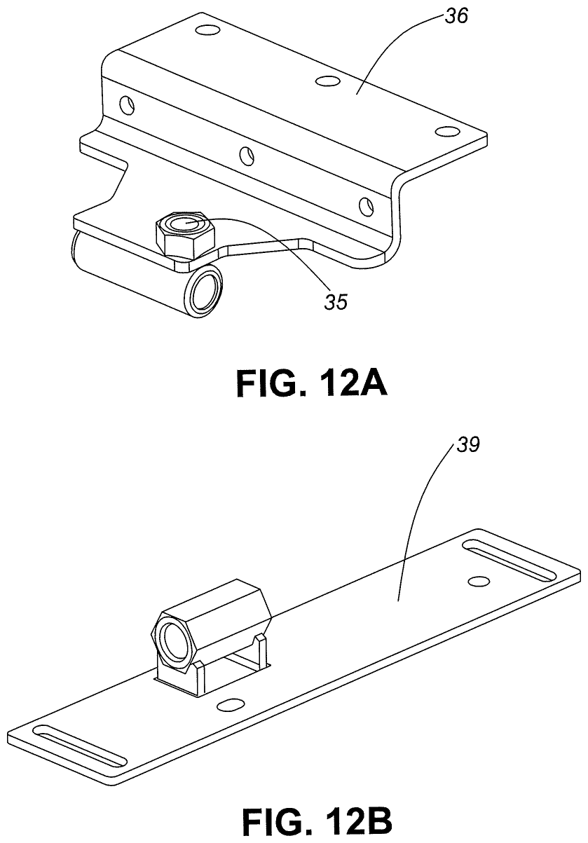

Exemplary first plate (36) and second plate (39) of the lower lifting hinge are illustrated in FIGS. 12A and 12B, respectively.

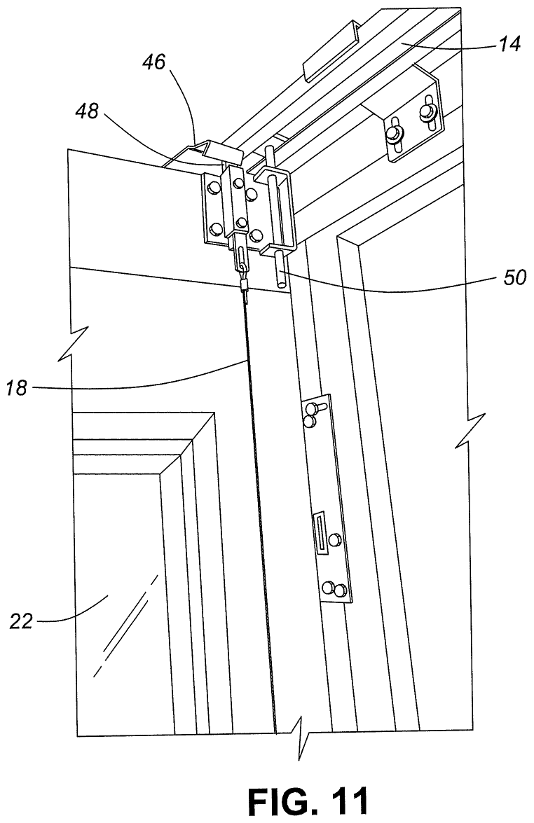

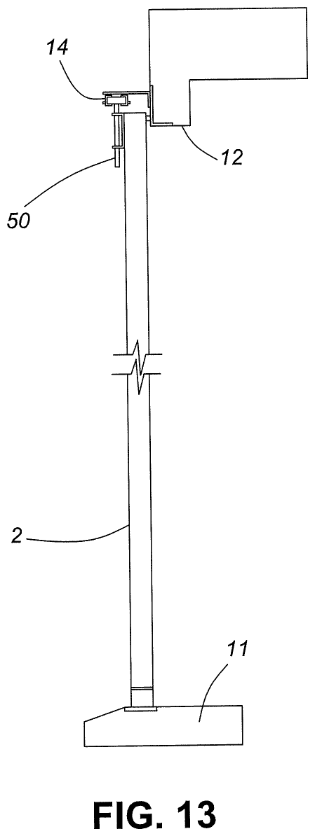

One embodiment disclosed herein comprises a folding door which cooperatively functions with a guide rail (14) situated on the top portion of the door frame. As illustrated in FIG. 11 or FIG. 13, for example, the door may comprise a pin or rod (50) which cooperatively fits with the guide rail (14) to effect sliding of the door along the guide rail (14), allowing the user to open and close the door (2) smoothly and easily. The guide rail may have sufficient space to allow for slight upward movement of the pin or rod (50) as the door opens and the lifting hinge causes the door to rise upward. The guide rail (14) may be attached to the upper door frame (12) by means of brackets, for example, to hold the guide rail (14) in a suitable position. The pin or rod (50) may engage with the guide rail by means of any frictionless or low friction sliding mechanism, such as, for example, a greased slider or ball bearing slider (not shown). In one embodiment, a bearing made of a low-friction material may be present. In one embodiment, the bearing may be made of neoprene, nylon or Delrin™. Further, the pin or rod (50) is attached to the door by means of a bracket or any suitable means. As the folding door opens, the orientation of the top edge of the door panels changes with respect to the guide rail (i.e. from a parallel position to a perpendicular position). Thus, either the pin or rod (50) or the frictionless or low friction sliding mechanism may be able to accommodate rotational movement about the axis of the pin or rod (50).

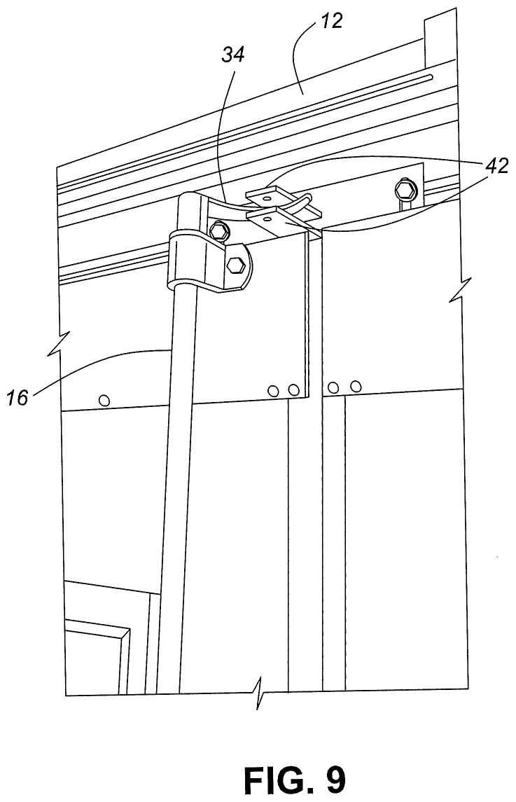

The door may comprise a first latch to maintain the door in a closed position. The latch may comprise a first engaging member (34) attached to the door which engages with a first retaining member (42) attached to the door frame. In some embodiments, the first engaging member (34) is actuated by a first actuating member (16), for example by a rod. The rod may be actuated by a cam lever (20) or any suitable mechanism. The first engaging member (34) may be any suitable feature such as a claw, protrusion, shoot, peg or other feature that engages with or locks into a first retaining member (42). In some embodiments, the first retaining member (42) may be a pair of protrusions with which the first engaging member (34) engages, or the first retaining member (42) may be any other suitable feature which retains the first engaging member (34), such as a guide or strap. As illustrated in FIG. 9, where the first engaging member (34) is actuated by a rod, the rotation of the rod may cause the first engaging member (34) to engage with the pair of protrusions, thus maintaining the door in a closed position. In an exemplary embodiment shown in FIG. 9 (see also FIG. 1), a handle (20) may be present on the front of the door and directly or indirectly connected to the rod, such as by means of a cam lever, such that when the handle is pulled, the rod is caused to rotate, thus rotating the first engaging member (34) away from the first retaining member (42) and allowing the door to open. Once released, the handle may default to a closed position, so that when it is desired to close the door, the rod is already in the correct position for the first engaging member (34) to engage with the first retaining member (42), so the first latch will close with a simple push of the door.

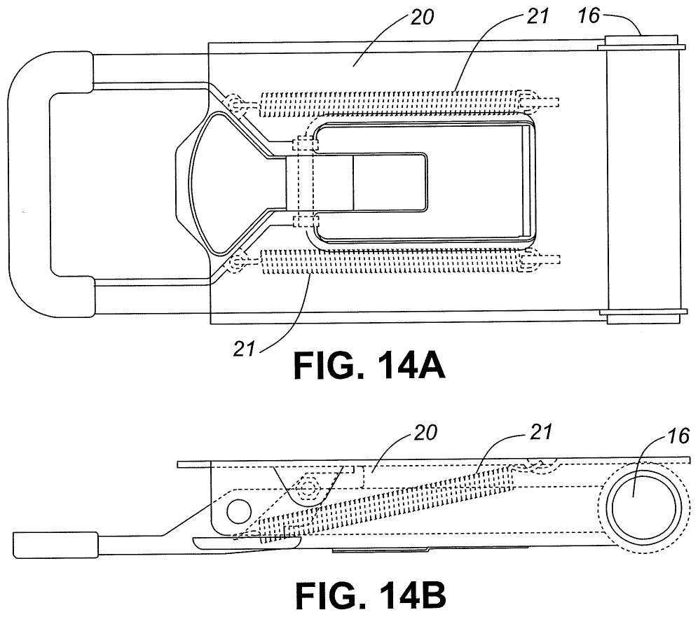

An exemplary embodiment of the handle (20) is shown in FIGS. 14A and 14B. Lifting the handle (20) causes first actuating member (16) to rotate and also pulls spring (21) into a stretched position. When the handle (20) is released, the spring (21) is also released, biasing the handle into a closed position.

The door may further comprise a second latch to releasably secure the door in an open position. As seen in FIG. 11, the second latch may comprise a second engaging member (48) attached to the door which engages with a second retaining member (46) attached to a portion of the door frame. In some embodiments, the second engaging member (48) may be a pin. In some embodiments, the second retaining member (46) may be a catch which receives the pin when the door is fully open. The pin may be released from the catch by a second actuating member (18) functioning by any means known in the art, including a draw chain.

In embodiments where the door comprises a thermal seal (28, 30) around the edges thereof, the second latch to maintain the door in a closed position is externally situated so as not to impinge on the door edges, thereby maintaining a thermal seal.

Optionally, the ground may slope downward from the sill on the exterior side of the door (see FIG. 13, for example).

The door may be fireproof if desired. The door may be watertight and waterproof if desired.

The previous detailed description has been provided for the purposes of illustration and description. Thus, although there have been described particular embodiments of the present invention, it is not intended that such references be construed as limitations upon the scope of this invention except as set forth in the following claims.

Thus, although there have been described particular embodiments of the present invention of a new and useful Insulated Door it is not intended that such references be construed as limitations upon the scope of this invention except as set forth in the following claims.

What is claimed is:

1. An insulated door surrounded by a door frame, the insulated door comprising:
one or more insulated panels;
a thermal seal secured to at least one edge of each of said one or more panels;
at least one lower lifting hinge and at least one upper sliding hinge connecting at least one panel to the door frame; and
an exterior mounted first latch for maintaining the insulated door in a closed position.

2. An insulated door as claimed in claim 1, wherein the thermal seal is secured to at least two edges, three or four edges of each of said one or more panels.

3. An insulated door as claimed in claim 2, wherein the door comprises two, three or four panels.

4. An insulated door as claimed in claim 3, wherein the door comprises a double door.

5. An insulated door as claimed in claim 1, wherein the thermal seals extend across at least 50% of a width of said one or more insulated panels.

6. An insulated door as claimed in claim 1, wherein the thermal seals secured to abutting edges of said one or more insulated panels are complementarily shaped to ensure a tight fit.

7. An insulated door as claimed in claim 5, wherein said complementarily shaped thermal seals comprise male-female configurations.

8. An insulated door as claimed in claim 1, further comprising:
a guide pin attached to a top edge of at least one of said one or more panels;
a guide rail mounted above the door and configured to slidably engage with the guide pin;
whereby the insulated door easily slides open and shut as the guide pin slides along the guide rail.

9. An insulated door as claimed in claim 3, further comprising:
a second latch for maintaining the door in an open position.

10. An insulated door as claimed in claim 1, wherein the at least one lower lifting hinge comprises:
a first plate comprising a first cylindrical housing and mounted to the door;
a second plate comprising a second cylindrical housing and mounted to the door frame;
a ramp secured to the second plate;
a rotating member secured to the first plate; and
a pin sized to fit within the first and second cylindrical housings;
wherein when the door is opened, the rotating member travels up the ramp while the first plate rotates about the pin, thus raising the door relative to the door frame.

11. An insulated door as claimed in claim 1, wherein the at least one upper sliding hinge comprises:
a first plate comprising a first cylindrical housing and mounted to the door;
a second plate comprising a second cylindrical housing and mounted to the door frame; and
a pin sized to fit within the first and second cylindrical housings;
wherein when the door is opened, the first plate rotates about the pin, while the door and first plate rise in relation to the pin.

12. An insulated door as claimed in claim 1, wherein the exterior mounted first latch comprises:
a first engaging member attached to the door which engages with a first retaining member attached to the door frame.

13. An insulated door as claimed in claim 12, wherein the first engaging member is actuated by a first actuating member.

14. An insulated door as claimed in claim 9, wherein the second latch is exterior mounted and comprises:
a second engaging member attached to the door;
a second retaining member attached to the door frame; and
a second actuating member which actuates the second engaging member to engage with or disengage from the second retaining member.

15. An insulated door as claimed in claim 8, wherein is adapted to accommodate upward movement of the guide pin as the door opens.

16. An insulated door as claimed in claim 15, wherein the guide pin engages with the guide rail by means of a frictionless or low friction sliding mechanism.

17. An insulated door as claimed in claim 16, wherein the frictionless or low friction sliding mechanism is adapted to accommodate rotational movement about the axis of the guide pin.
